(19) United States
(12) Patent Application Publication
(10) Pub. No.: US 2008/0180944 A1
(43) Pub. Date: Jul. 31, 2008

(54) Light for tool box

(76) Inventors: Matthew J. Galvez, Pasadena, CA (US); James M. Galvez, San Dimas, CA (US)

Correspondence Address: Rutan & Tucker, LLP., 611 ANTON BLVD, SUITE 1400, COSTA MESA, CA, 92626, US

(21) Appl. No.: 11/701,299

(22) Filed: Jan. 31, 2007

(51) Int. Cl. F21V 33/00

(52) U.S. Cl. 362/154

(57) ABSTRACT

A low-profile light source is coupled to the underside of a toolbox such that the light source is not directly visible and light is emitted from underneath the toolbox. Most preferably, the low-profile light source is a colored neon light and produces a “ground effect” similar to that of underbody neon lighting in tuner cars.

### FIELD OF THE INVENTION

The field of the invention is lighting devices, and especially decorative external lighting elements for toolboxes.

### BACKGROUND OF THE INVENTION

Decorative light fixtures (i.e., light fixtures that are not required to sufficiently illuminate a work area) are common in many commercial and residential settings, and are typically used to enhance a particular ambience. However, purely decorative light fixtures are much less common in a professional setting as they may be viewed as detracting from activities in such settings. For example, most restaurants or retail spaces will have spot lights to highlight artwork, plaques, or other decorative items. In contrast, workshops will typically lack decorative lighting and include purely functional lighting elements to illuminate specific work areas or objects. Therefore, there is still a need to provide apparatus and methods for decorative lighting in professional settings, and especially in workshops.

### SUMMARY OF THE INVENTION

The present invention is directed to kits, apparatus, and methods in which a low-profile light source is coupled to the underside of a toolbox to provide a “ground-effect” glow in and around the footprint of the toolbox.

In one aspect of the inventive subject matter, a method of assisting a person to modify a toolbox has a step in which a low-profile light source is provided. In a another step, the person is instructed to mount the low-profile light source to the underside of a toolbox such that when the toolbox is placed on the floor, light from the light source is radiated from the underside of the toolbox to a position outside of the footprint of the toolbox, and such that the low-profile light source is not directly visible to the person when the person stands at a distance of 5 feet from the toolbox.

In another aspect of the inventive subject matter, a kit may include a low-profile light source and an instruction to mount the low-profile light source to the underside of a toolbox such that when the toolbox is placed on a floor, light from the low-profile light source is radiated from of the underside to a position outside of the footprint of the toolbox, and such that the low-profile light source is not directly visible to the person when the person stands at a distance of 5 feet from the toolbox. Consequently, the inventors also contemplate a toolbox that has a low-profile light source coupled to an underside of the toolbox such that when the toolbox is placed on a floor, light from the low-profile light source is radiated from of the underside to a position outside of the footprint of the toolbox, and such that the low-profile light source is not directly visible to the person when the person stands at a distance of 5 feet from the toolbox.

Contemplated toolboxes include portable toolboxes, i.e. those intended to be carried about using a single hand, and also all manner of non-portable toolboxes, which are defined herein as including completely stationary toolboxes, wheeled toolboxes (that are too heavy to carry about, and are instead moved about on casters or other elements), supported toolboxes (in which the underside of the toolbox is suspended off the ground by, e.g., rails or posts), and all other types of toolboxes. The low-profile light source preferably emits a colored light and is a neon light, a fluorescent light, an incandescent puck light, or more or more LEDs. Even more preferably, the low-profile light source is coupled to a translucent or transparent impact shield to protect the low-profile light source and the low-profile light source is coupled to a mounting element (e.g., high-tack adhesive, hook-and-loop fastener, magnet, etc.) that allows tool-less mounting and/or removal of the low-profile light source to and from the toolbox. Additionally provided items may include a power source, a power cord, a power switch, a transformer, and/or wiring.

Various objects, features, aspects and advantages of the present invention will become more apparent from the following detailed description of preferred embodiments of the invention.

### BRIEF DESCRIPTION OF THE DRAWING

FIG. 1 is a plan view of an exemplary kit according to the inventive subject matter.

FIG. 2 is a detail view of a component of the kit of FIG. 1.

FIG. 3 is a schematic drawing illustrating a toolbox with ground-effect according to the inventive subject matter.

### DETAILED DESCRIPTION

The inventors have discovered that conventional and custom toolboxes can be upgraded with a low-profile light source to add visual appeal to toolboxes of different portabilities. Most preferably, the low-profile light source is a conventional neon light that is encased in a protective transparent cover, and that is mounted to the underside of the toolbox with a pair of magnetic mounting elements. Power to such configurations is typically provided by a regular wall outlet via cable, transformer, and switch, which are most preferably (but nor necessarily) mounted to the underside of the toolbox.

With respect to suitable toolboxes it is generally contemplated that all known toolboxes are deemed suitable for use herein. However, especially preferred toolboxes are non-portable (i.e., cannot be conveniently carried by a single person using one hand) and will typically include a plurality of casters or other rolling devices to permit movement of the toolbox in the shop. Thus, the size of preferred toolboxes is typically between about 20-150 inches wide, between 10-100 inches deep, and between 15-100 inches high. Such toolboxes will typically be manufactured from metal or metal alloys, and include a plurality of drawers, doors, and bins, and further provide a work surface. Alternatively, the toolbox may also be portable and of considerably smaller size. For example, portable toolboxes will be between about 10-20 inches wide, between 6-20 inches deep, and between 5-15 inches high and may have posts to suspend the toolbox.

It should be noted that where the toolbox does not originally have casters, rollers, posts, rails, or other implements that keep the underside of the toolbox off the ground, such casters, rollers, posts, rails, or other implements can be provided with the low-profile light source. Most preferably, the implements are casters, posts, or rails that provide for at least 0.5 inches, more preferably at least 1 inch, and most preferably 1.5 inches of clearance. In further contemplated and less preferred aspects, it should be appreciated that suitable containers need not be limited to toolboxes, but may also include other storage units, including garage organizers, closets, and cabinets, which may be suspended off the ground by casters, posts, etc, or which may be coupled to a wall in an elevated position to provide vertical clearance.

The low-profile light source is preferably a neon light tube, which is most preferably a single straight tube of about 10-25 inches in length and about ¼ to ½ inch diameter. The term “low-profile light source” as used herein refers to any light source in which at least one of the length and width is at least 2 times the height. In most preferred aspects of the inventive subject matter, the neon light is encased in a housing to protect the neon light from mechanical impact. Preferably, the housing is transparent or translucent and may be colored or clear, and is typically manufactured from high-density polyethylene, polycarbonate, or other impact resistant polymer that conforms in shape to the neon light. In further preferred aspects, one or more spacers are disposed between the light source and the housing to maintain the light source in predetermined distance to the housing and to dampen vibration.

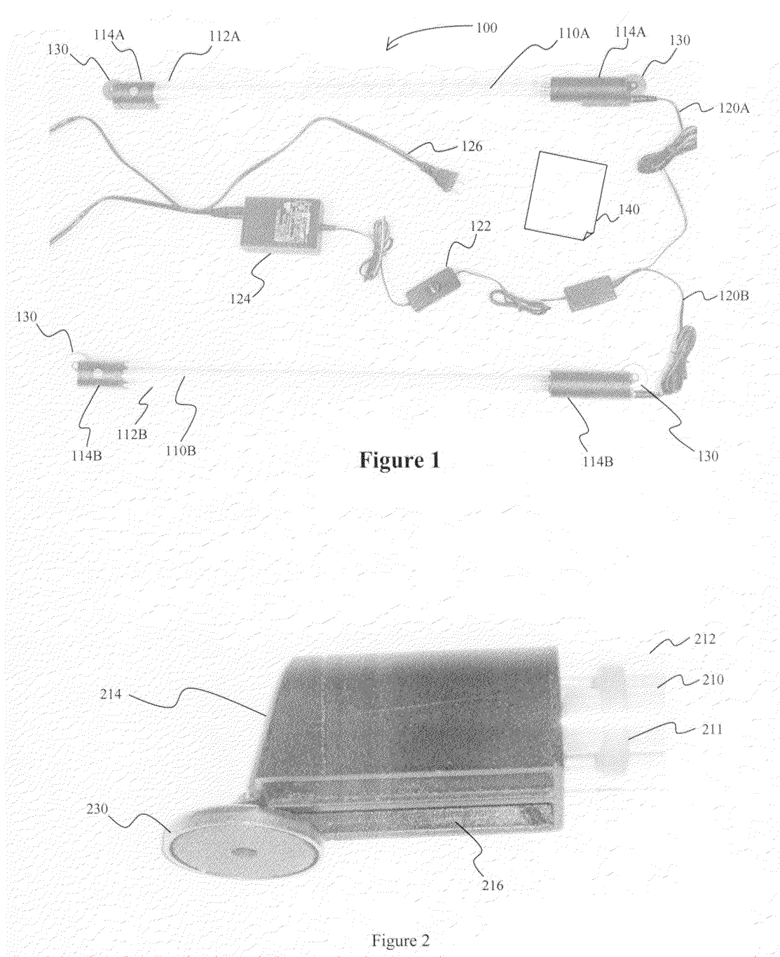

An exemplary low-profile light source kit is depicted in FIG. 1, in which assembly 100 comprises first and second low-profile light sources 110A and 110B, which are disposed in respective impact protectors 112A and 112B. End caps 114A and 114B are coupled to the end of the neon lights and provide for electrical connection with power cord 120A and 120B that are spliced together and electrically connect to switch 122, transformer 124, and outlet power cord 126. Mounting elements 130 are magnetic discs that are coupled to the end caps. Instruction manual 140 provides instructions to mount the low-profile light source to an underside of a toolbox such that when the toolbox is placed on a floor, light from the low-profile light source is radiated from of the underside to a position outside of a footprint of the toolbox, and such that the low-profile light source is not directly visible to the person when the person stands at a distance of 5 feet from the toolbox. Further contemplated configurations and methods include those in which the light source is coupled to a dimmer, timer, light sensor, and/or a control unit to achieve a particular effect (e.g., color change, on/off switching). Most preferably, wiring between the components is included in a kit, and where desirable, a battery may be included to provide a power source.

FIG. 2 provides a detailed view of the end of one device in which the end cap 214 matingly receives the light source 210 and impact protector 212. Spacer element 211 is disposed between the light source and the impact protector, and the magnetic mounting element is movably coupled to the end cap via track 216.

It should be appreciated, however, that numerous alternative configurations for the low-profile light source are also suitable, and especially contemplated light sources include neon lights in a configuration other than straight (e.g., circular, wave shaped, rectangular, irregular, etc.) and fluorescent light bulbs that will typically be colored or coupled to a colored impact protector. Further contemplated alternative light sources include incandescent puck lights (or otherwise low-profile dimensioned shapes, such as bars, circles, etc.), and LED-containing assemblies (most typically in strings).

Regardless of the particular type of light source, it is generally contemplated that the light source emits a colored light (e.g., blue, pink, red, yellow, green, etc.), which may be a single color, or multiple colors. Emission of the colored light may be continuous and in a single color, or electronically controlled to display multiple colors. For example, and especially where high-intensity LEDs are the light source, preprogrammed color changes or blinking effects may be achieved, which may be triggered by environmental factors, including noise, opening or closing a drawer, etc. With respect to the size of the light source, it is contemplated that the longest dimension of the light sources is preferably at least 50%, more preferably at least 70%, and most preferably at least 80% of the length of the underside of the toolbox to which the light source is coupled. For example, where the toolbox measures 60 inches side-to-side and 30 inches front-to-back, suitable side-to-side light sources will measure at least 30 inches, more typically 45 inches, and more preferably at least 52 inches, and suitable front-to-back light sources will measure at least 15 inches, more typically 20 inches, and more preferably at least 26 inches. Thus, it should be recognized that the light emitted by the light source is a decorative light and is therefore not primarily used to illuminate a work surface (i.e., bench top) or an inside of the tool box. However, where desired, corresponding colored lighting inside the toolbox is also contemplated (e.g., via light guides or small additional light sources within the drawer of closet. Most preferably, such additional light sources are also mounted such that the light source is not directly visible by the person when the person stands at a distance of 5 feet from the toolbox, and the drawer or closet is partially opened.

Furthermore, it is generally preferred that the light sources are selected, dimensioned, and coupled to the underside of the toolbox such that the light emitted from the light sources has equally strong visual appearance around the toolbox. In especially preferred aspects, the low-profile light source is mounted to the underside of the toolbox such that when the toolbox is placed on the floor, light from the low-profile light source is radiated from of the underside to a position outside of the footprint of the toolbox, and such that the low-profile light source is not directly visible to the person (having a height of 6 feet) when the person stands at a distance of 2, more preferably 4, and most preferably 5 feet from the toolbox. For example, where the toolbox includes a lower lip or kickboard, the low-profile light source may be hidden behind and mounted to the lower lip or kickboard. On the other hand, where no such structure is available, the light source may be mounted more closely to the center of the underside of the toolbox. Alternatively, a lower lip, band, or other structure may be provided, which may or may not be integral or otherwise coupled to the impact protector.

Depending on the available structures on the underside of the toolbox, suitable mounting elements may vary, and especially preferred mounting elements are those that allow tool-less mounting and removal of the low-profile light source from the toolbox. For example, suitable mounting elements include high-tack adhesive, a hook-and-loop fastener, and magnets, however, in less preferred aspects, mounting elements requiring tools are also deemed suitable. While it is expected that a person of ordinary dexterity will be able to couple the light source to the toolbox, instructions for such coupling and use with toolboxes may be provided in printed, displayed, and/or pictorial format.

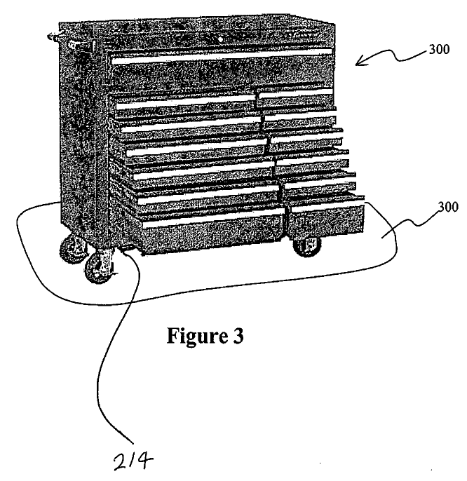

Consequently, the inventors contemplate methods and kits that includes a low-profile light source and an instruction to mount the low-profile light source to an underside of a toolbox such that (a) when the toolbox is placed on a floor, light from the low-profile light source is radiated from of the underside to a position outside of a footprint of the toolbox; and (b) the low-profile light source is not directly visible to the person when the person stands at a distance of 5 feet from the toolbox. Using such methods and kits, an exemplary toolbox with ground-effect by a low-profile light source is schematically illustrated in FIG. 3. Here, non-portable toolbox 300 has four low-profile light sources (not visible) coupled to the underside such that light 310 from the low-profile light source is radiated from the underside of the toolbox to a position outside of a footprint of the toolbox while the low-profile lights (and with that direct light from the low-profile light) is not visible.

Thus, specific embodiments and applications of tuner toolboxes have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

1. A method of assisting a person to modify a toolbox, comprising:
providing a low-profile light source; and
instructing the person to mount the low-profile light source to an underside of a toolbox such that
(a) when the toolbox is placed on a floor, light from the low-profile light source is radiated from of the underside to a position outside of a footprint of the toolbox;
(b) the low-profile light source is not directly visible to the person when the person stands at a distance of 5 feet from the toolbox; and
(c) the low-profile light source provides a decorative light that is not used to illuminate a work surface.

2. The method of claim 1 wherein the toolbox is a non-portable toolbox and wherein the underside of the toolbox is suspended off the ground by a plurality of casters.

3. The method of claim 1 wherein the toolbox is a portable toolbox and wherein the underside of the toolbox is suspended off the ground by a plurality of rails or posts.

4. The method of claim 1 wherein the low-profile light source emits a colored light and is selected from the group consisting of a neon light, a fluorescent light, an incandescent puck light, and an LED.

5. The method of claim 1 wherein the low-profile light source is coupled to a translucent or transparent impact shield that is configured to cover the low-profile light source.

6. The method of claim 1 wherein the low-profile light source is coupled to a mounting element that allows tool-less mounting and removal of the low-profile light source from the toolbox.

7. The method of claim 1 wherein the mounting element is selected form the group consisting of a high-tack adhesive, a hook-and-loop fastener, and a magnet.

8. The method of claim 1 further comprising providing at least one of a power source, a power cord, a power switch, a transformer, and wiring.

9. The method of claim 1 wherein the step of instructing is achieved by providing at least one of pictorial information and written information.

10. A kit comprising: a low-profile light source and an instruction to mount the low-profile light source to an underside of a toolbox such that (a) when the toolbox is placed on a floor, light from the low-profile light source is radiated from of the underside to a position outside of a footprint of the toolbox; (b) the low-profile light source is not directly visible to the person when the person stands at a distance of 5 feet from the toolbox, and (c) the low-profile light source provides a decorative light that is not used to illuminate a work surface.

11. The kit of claim 10 wherein the toolbox is a non-portable toolbox and wherein the underside of the toolbox is suspended off the ground by a plurality of casters.

12. The kit of claim 10 wherein the toolbox is a portable toolbox and wherein the underside of the toolbox is suspended off the ground by a plurality of rails or posts.

13. The kit of claim 10 wherein the low-profile light source emits a colored light and is selected from the group consisting of a neon light, a fluorescent light, an incandescent puck light, and an LED.

14. The kit of claim 10 further comprising at least one of a mounting element, an impact shield that is configured to cover the low-profile light source, and electrical components selected from the group consisting of a power source, a power cord, a power switch, a transformer, and wiring.

15. The kit of claim 10 wherein the low-profile light source is a neon light that is coupled to a mounting element that allows tool-less mounting and removal of the low-profile light source from the toolbox.

16. A toolbox comprising a low-profile light source coupled to an underside of the toolbox such that when the toolbox is placed on a floor, (a) light from the low-profile light source is radiated from of the underside to a position outside of a footprint of the toolbox, (b) the low-profile light source is not directly visible to the person when the person stands at a distance of 5 feet from the toolbox and (c) the low-profile light source provides a decorative light that is not used to illuminate a work surface.

17. The toolbox of claim 16 wherein the toolbox is configured as non-portable toolbox and wherein the underside of the toolbox is suspended off the ground by a plurality of casters.

18. (canceled)

19. The toolbox of claim 16 wherein the low-profile light source is a neon light that is configured to emit a colored light.

20. The toolbox of claim 16 wherein the low-profile light source is coupled to a mounting element that allows tool-less mounting and removal of the low-profile light source from the toolbox.
